(19) United States
(12) Patent Application Publication
(10) Pub. No.: US 2026/0169695 A1
(43) Pub. Date: Jun. 18, 2026

(54) INTEGRATED LOGIC CIRCUIT WITH FUSED MULTIPLIER AND ADDER (FMA) OR FUSED MULTIPLIER AND ACCUMULATOR (FMAC) INTEGRATED WITH FUNCTION EVALUATION LOGIC

(71) Applicant: Microsoft Technology Licensing, LLC, Redmond, WA (US)

(72) Inventors: Kyung-Nam HAN, Oviedo, FL (US); Dushyanth BHOJARAJA, Fremont, CA (US); Tariq Ahmed THAJUDEEN, Folsom, CA (US)

(73) Assignee: Microsoft Technology Licensing, LLC, Redmond, WA (US)

(21) Appl. No.: 18/985,769

(22) Filed: Dec. 18, 2024

(51) Int. Cl. G06F 7/544; G06F 7/485

(52) U.S. Cl. CPC G06F 7/5443; G06F 7/485

(57) ABSTRACT

Systems and methods are provided for implementing an integrated logic circuit with fused multiplier and adder (“FMA”) or fused multiplier and accumulator (“FMAC”) integrated with function evaluation logic. In examples, an integrated logic circuit, which includes an FMA or FMAC logic portion and an integrated function evaluation logic portion, receives a first value corresponding to a variable of a function evaluated using the function evaluation logic portion. The integrated logic circuit produces a second value by performing a function operation based on the first value and the function. An adder logic concurrently receives the second value directly from the function evaluation logic portion and a third value. The integrated logic circuit produces a fourth value by adding the second and third values, using the adder logic. The fourth value undergoes normalization and rounding to produce an output value, which is output by the integrated logic circuit.

### BACKGROUND

With the growing popularity and increasing use of artificial intelligence (“AI”) systems (such as generative AI systems like large language models (“LLMs”)), the number of AI and/or machine learning (“ML”) tasks continues to increase exponentially. AI/ML tasks heavily employ multiply-add (“MAD”) or multiply-accumulate (“MAC”) operations. Operations like SoftMax are important operations in the hardware acceleration of LLMs, but such operations require computing the sum of exponential function values, which traditionally requires tens of thousands of clock cycles. It is with respect to this general technical environment to which aspects of the present disclosure are directed. In addition, although relatively specific problems have been discussed, it should be understood that the examples should not be limited to solving the specific problems identified in the background.

### SUMMARY

This summary is provided to introduce a selection of concepts in a simplified form that are further described below in the detailed description section. This summary is not intended to identify key features or essential features of the claimed subject matter, nor is it intended as an aid in determining the scope of the claimed subject matter.

The currently disclosed technology, among other things, provides for an integrated logic circuit with a fused multiplier and adder (“FMA”) or a fused point multiplier and accumulator (“FMAC”) integrated with function evaluation logic. In examples, an integrated logic circuit, which includes a function evaluation logic portion and an FMA or FMAC logic portion that is integrated with the function evaluation logic portion, receives a first value that corresponds to a variable of a function that is evaluated using the function evaluation logic portion. The integrated logic circuit produces a second value by performing a function operation based on the first value and based on the function. An adder logic of the FMA logic portion concurrently receives the second value directly from the function evaluation logic portion and a third value. The integrated logic circuit, using the adder logic, produces a fourth value by adding the second and third values. The integrated logic circuit normalizes the fourth value, rounds the normalized fourth value, and outputs an output value based on the normalized fourth value. For an integrated logic circuit with FMAC, the output value is stored in an accumulator register.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIGS. 1A-1C depict example systems for implementing an integrated logic circuit with an FMA or FMAC integrated with function evaluation logic.

FIG. 2A depicts an example system for implementing an integrated logic circuit with an FMAC integrated with function evaluation logic for a 2\hat{ }x exponential function.

FIG. 2B depicts an example system for implementing an integrated logic circuit with an FMAC integrated with function evaluation logic for an e\hat{ }x exponential function.

FIG. 3 depicts an example method for implementing an integrated logic circuit with an FMA integrated with function evaluation logic.

FIG. 4 depicts another example method for implementing an integrated logic circuit with an FMA or FMAC integrated with function evaluation logic.

FIGS. 5A and 5B depict yet another example method for implementing an integrated logic circuit with an FMAC integrated with function evaluation logic.

### DETAILED DESCRIPTION OF CERTAIN EMBODIMENTS

As briefly discussed above, operations like SoftMax are important operations in the hardware acceleration of LLMs, but such operations require computing the sum of exponential function values, which traditionally requires tens of thousands of clock cycles. Conventional methods for calculating such operations involve two steps: (1) calculating exponential function values using dedicated hardware in a floating point number format; and (2) accumulating the evaluated values using a floating point FMA. Accordingly, such conventional methods require use of dedicated hardware for evaluation of the exponential function, and the FMA hardware separately requires two instructions, one for the exponential function evaluation and another for the FMA calculation. Further, outputs for the function evaluation hardware are stored in registers whose stored values are input into the FMA hardware. For example, conventional hardware would perform the following steps for equation “z=ƒ(x(1))+ƒ(x(2))+ . . . +ƒ(x(n))”:
(a) function evaluation for x(1), with result (namely, ƒ(x(1))) stored in a first register;
(b) function evaluation for x(2), with result (namely, ƒ(x(2))) stored in a second register;
(c) FMA calculation for ƒ(x(1))+ƒ(x(2)), with the sum stored in an accumulator register;
(d) function evaluation for x(3), with result (namely, ƒ(x(3))) stored in a third register (which may be one of the first or second registers);
(e) FMA calculation for ƒ(x(3))+an accumulated value stored in the accumulator register, with the results stored in the accumulator register;
. . . .

The present technology provides for an integrated logic circuit with an FMA or FMAC integrated with function evaluation logic. In particular, the present technology combines the two operations (namely, function evaluation and FMA or FMAC calculation) into a single instruction by merging or integrating the function evaluation hardware logic and the FMA or FMAC hardware logic. Further, the present technology is applicable to not only the exponential function operations, but a logarithmic function, a trigonometric function, a hyperbolic tangent function, a reciprocal function, a square root function, a reciprocal of a square root function, a sigmoid function, and/or a Gaussian error linear unit (“GELU”) function as well. Using the example above, the integrated logic circuit would perform the following steps for equation “z=ƒ(x(1))+ƒ(x(2))+ . . . +ƒ(x(n))”:
(A) function evaluation from an integrated FMA or FMAC for x(1), with the sum stored in an accumulator register;
(B) function evaluation from an integrated FMA or FMAC for x(2)+an accumulated value stored in the accumulator register, with the results (namely, ƒ(x(1))+ƒ(x(2))) stored in the accumulator register;
(C) function evaluation from an integrated FMA or FMAC for x(3)+the accumulated value stored in the accumulator register, with the results (namely, ƒ(x(1))+ƒ(x(2))+ƒ(x(3))) stored in the accumulator register;
. . . .

Accordingly, comparing the steps performed by the integrated logic circuit and by the conventional hardware logic (i.e., separate function evaluation hardware and FMA hardware), the same operations performed by the integrated logic circuit (as described herein) require fewer steps, fewer hardware components (e.g., registers for storing intermediate values and components for linking the registers to the hardware components), and fewer instructions, without any increase in latency. Where an FMA or FMAC combines the multiplication operation and the adding operation in one step (or fused operation), with a single rounding (compared with an MAD or an MAC) the integrated logic circuit of the present technology goes a step further by combining the function evaluation and the FMA or FMAC operation, with a single rounding.

Various modifications and additions can be made to the embodiments discussed herein without departing from the scope of the disclosed techniques. For example, while the embodiments described above refer to particular features, the scope of the disclosed techniques also includes embodiments having different combinations of features and embodiments that do not include all of the above-described features.

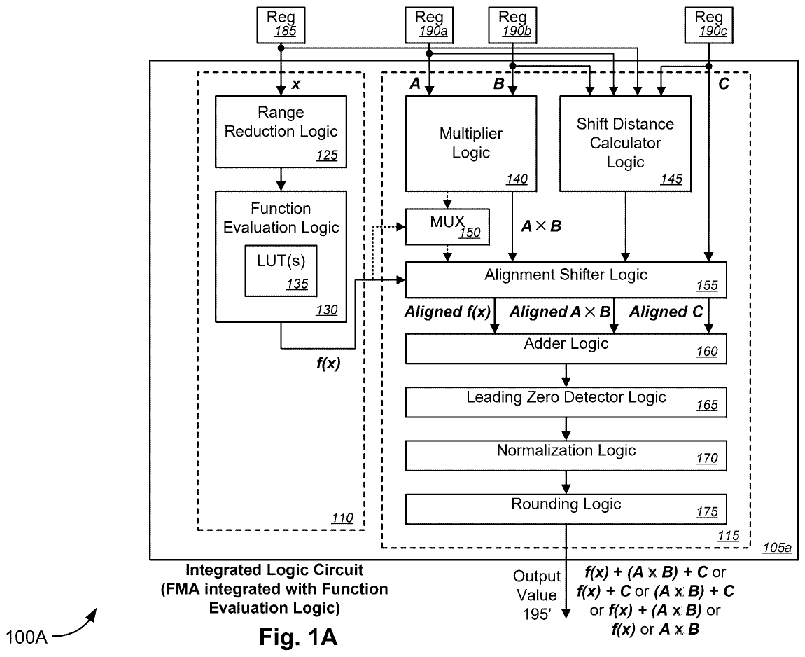

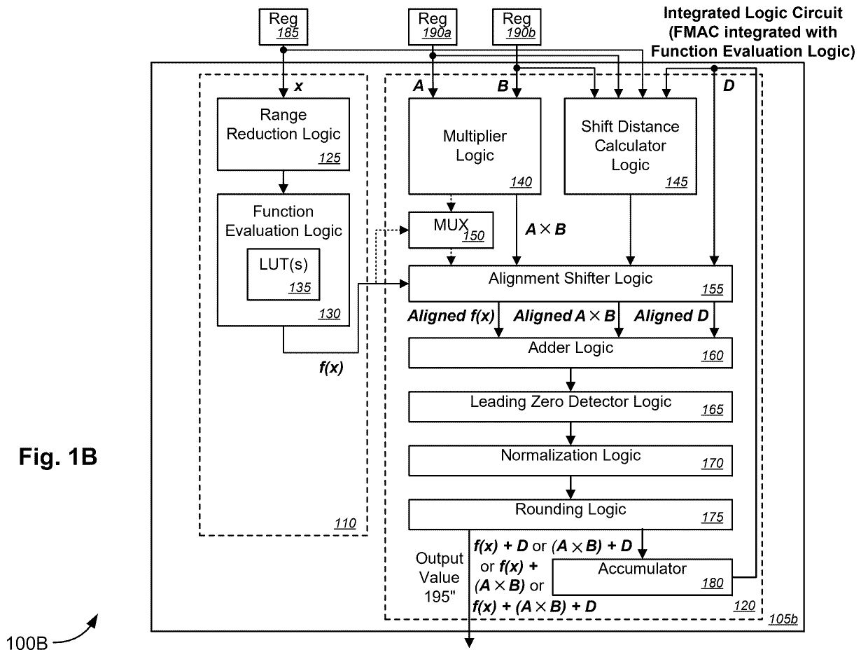

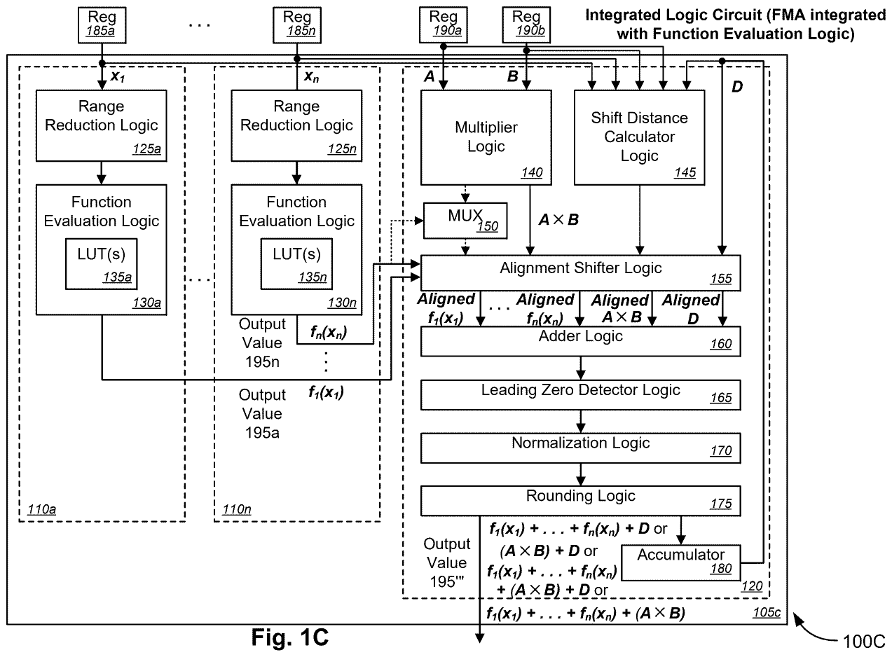

Turning to the embodiments as illustrated by the drawings, FIGS. 1A-5B illustrate some of the features of methods, systems, and apparatuses for implementing an integrated logic circuit with an FMA or FMAC integrated with function evaluation logic, as referred to above. The methods, systems, and apparatuses illustrated by FIGS. 1A-5B refer to examples of different embodiments that include various components and steps, which can be considered alternatives or which can be used in conjunction with one another in the various embodiments. The description of the illustrated methods, systems, and apparatuses shown in FIGS. 1A-5B is provided for purposes of illustration and should not be considered to limit the scope of the different embodiments.

FIGS. 1A-1C depict example systems 100A-100C for implementing an integrated logic circuit with an FMA or FMAC integrated with function evaluation logic. FIG. 1A is directed to an example system 100A for implementing an integrated logic circuit with an FMA integrated with function evaluation logic, while FIG. 1B is directed to an example system 100B for implementing an integrated logic circuit with an FMAC integrated with function evaluation logic, and FIG. 1C is directed to an example system 100C for implementing an integrated logic circuit with an FMAC integrated with a plurality of function evaluation logic portions.

With reference to FIG. 1A, system 100A includes an integrated logic circuit 105a that includes a function evaluation logic portion 110 and an FMA portion 115 that is integrated with the function evaluation logic portion 110. Similarly, in FIG. 1B, system 100B includes an integrated logic circuit 105b that includes a function evaluation logic portion 110 and an FMAC portion 120 that is integrated with the function evaluation logic portion 110. In FIG. 1C, system 100C includes an integrated logic circuit 105c that includes a plurality of function evaluation logic portions 110a-110n and an FMAC portion 120 that is integrated with the plurality of function evaluation logic portions 110a-110n.

In each of systems 100A-100C of FIGS. 1A-1C, respectively, each function evaluation logic portion 110 includes a range reduction logic (e.g., range reduction logic 125 of FIGS. 1A and 1B or range reduction logic 125a-125n of FIG. 1C), a function evaluation logic (e.g., function evaluation logic 130 of FIGS. 1A and 1B or function evaluation logic 130a-130n of FIG. 1C), and one or more look-up tables (“LUTs”) (e.g., LUT(s) 135 of FIGS. 1A and 1B or LUT(s) 135a-135n of FIG. 1C). In examples, each function evaluation logic 130 or 130a-130n performs a function including a transcendental function including at least one of an exponential function, a logarithmic function, a trigonometric function, a hyperbolic tangent function, a reciprocal function, a square root function, a reciprocal of a square root function, a sigmoid function, or a GELU function. In the case of floating point values, the function includes at least one of a floating point exponential function, a floating point logarithmic function, a floating point trigonometric function, a floating point hyperbolic tangent function, a floating point reciprocal function, a floating point square root function, a reciprocal of a floating point square root function, a floating point sigmoid function, or a floating point GELU function.

In an example, the FMA portion 115 includes a multiplier logic 140, a multiplexer (“MUX”) 150, an alignment shifter logic 155, an adder logic 160, a normalization logic 170, and a rounding logic 175, while the FMAC portion 120 is similar to the FMA portion 115, except that the FMAC portion 120 further includes an accumulator register 180. In another example, the FMA portion 115 (such as shown in FIG. 1A) includes a multiplier logic 140, a shift distance calculator logic 145, a MUX 150, an alignment shifter logic 155, an adder logic 160, a leading zero detector logic (“LZD logic”) 165, a normalization logic 170, and a rounding logic 175, while the FMAC portion 120 (such as shown in FIGS. 1B and 1C) includes a multiplier logic 140, a shift distance calculator logic 145, a MUX 150, an alignment shifter logic 155, an adder logic 160, an LZD logic 165, a normalization logic 170, a rounding logic 175, and an accumulator register 180. In an example, alternative to the LZD logic 165 (whose input is the output of the adder logic 160), a leading zero anticipator (“LZA”) logic can instead be used that is parallel with the adder logic 160, and that takes as input the same input values as the adder logic 160, while outputting to the normalization logic 170. In another example, the LZD logic 165 (or the LZA logic) is part of the normalization logic 170. In other examples, the FMA portion 115 or the FMAC portion 120 does not include one of the MUX 150 or the LZD logic 165 (or the LZA logic). In some instances, the shift distance calculator logic 145 is external to the FMA portion 115 or the FMAC portion 120.

Turning back to example system 100A of FIG. 1A, the range reduction logic 125 of the function evaluation logic portion 110 receives a first value (in this case, “x”) from a first register 185, and performs range reduction operations on the first value. For floating point range reduction, the floating point format of the first value (which may have a range from negative infinity to positive infinity) is converted to a fixed point number format. Each function has a different evaluation range in the function evaluation step. For example, an exponential function with a base of 2 represented by 2\hat{ }x has an evaluation range from zero to one, while a reciprocal function represented by 1/x has a range from one to two. In some cases, range reduction operations include changing the dimensions of the value whose range is being reduced, in some cases, by converting the first value into an integer part and a fractional part to evaluate function operation of the first value within a particular range, such as described above. In examples, the function evaluation logic 130 produces a second value by performing a function operation based on the first value (in the fixed point number format). In some cases, the function evaluation logic 130 performs the function operation based on the first value by either querying LUT(s) 135 (which, in some cases, is part of the function evaluation logic 130, such as shown in FIGS. 1A and 1B) or performing polynomial approximation, depending on a desired output precision. In some cases, querying the LUT(s) 135 or performing polynomial approximation is performed using a range reduced value of the first value (e.g., the integer part and the fractional part converted from the first value by the range reduction operations performed by range reduction logic 125). After evaluation, the second value (in this case, “ƒ(x)”), which is produced by the evaluation step, is input into either the MUX 150 or the alignment shifter logic 155 of the FMA logic portion 115.

In some examples, the multiplier logic 140 receives a third value (in this case, “A”) from a second register 190a and a fourth value (in this case, “B”) from a third register 190b, and produces a product value (in this case, “A×B”) by multiplying the third and fourth values. In examples, when adding two values, the shift distance calculator logic 145 calculates a shift distance for aligning bits of one value corresponding to a mantissa of the first value with bits of another value corresponding to a mantissa of the other value, while the alignment shifter logic 155 performs alignment by shifting bits of the one value based on the calculated shift distance. In other examples, when adding three or more values, the shift distance calculator logic 145 identifies a maximum exponent value among the three or more values, subtracts each exponent value from the maximum exponent value, and calculates a shift distance for each of the third or more values by subtracting the exponent value for that value from the maximum exponent value. In examples, the first value (in this case, “x”) from the first register 185, the third value (in this case, “A”) from the second register 190a, the fourth value (in this case, “B”) from the third register 190b, and/or a fifth value (in this case, “C”) from a fourth register 190c are input into the shift distance calculator logic 145, and an output from the shift distance calculator logic 145 is used to control the alignment shifter logic 155.

In an example, the second value (in this case, “ƒ(x)”) from the function evaluation logic 130, the product value (in this case, “A×B”) from the multiplier logic 140, and the fifth value (in this case, “C”) from the fourth register 190c are added together, in which case, alignment shifting is calculated by the shift distance calculator logic 145 for these three values according to the following: (a) a maximum exponent value among the three values is identified; (b) each exponent value is subtracted from the maximum exponent value; and (c) a shift distance for each value is calculated by subtracting the exponent value for that value from the maximum exponent value. The alignment shifter logic 155 shifts bits based on the calculated shift distance for each of these three values. The FMA logic portion 115, using the adder logic 160, produces a sum value, by adding bit-shifted values for the second value (e.g., “ƒ(x)”), the product value (e.g., “A×B”), and the fifth value (e.g., “C”). In such a case, the value with the maximum exponent value need not be bit-shifted, but would be added to the other two values, which would be bit-shifted. After summing, the FMA logic portion 115 performs floating point range recovery, by converting the fixed point evaluated value back to the floating point number format, and the output floating point range is recovered by calculating using the first input value's floating point exponent values, in some cases, as part of the normalization and rounding steps. In other cases, range recovery is performed prior to summing. In examples, the FMA logic portion 115 normalizes, using the normalization logic 170, the sum value to produce a first normalized value, and rounds, using the rounding logic 175, the first normalized value to produce an output value 195′ (in this case, “ƒ(x)+(A×B)+C”), and outputs the output value 195′. In another example, where the fifth value (e.g., “C”) is zero, one of the second value (e.g., “ƒ(x)”) and the product value (e.g., “A×B”) is bit-shifted, prior to summing. After summing, performing floating point range recovery, normalizing, and rounding, the FMA logic portion 115 outputs the output value 195′ (in this case, “ƒ(x)+(A×B)”). In yet another example, where the fifth value (e.g., “C”) and the second value (e.g., “ƒ(x)”) are each zero, the FMA logic portion 115 outputs the output value 195′ (in this case, “(A×B)”). In still another example, where the fifth value (e.g., “C”) and one of the third value (e.g., “A”) or the fourth value (e.g., “B”) are each zero, the FMA logic portion 115 outputs the output value 195′ (in this case, “ƒ(x)”). In some examples, some functions ƒ(x) (e.g., 2\hat{ }x) have output values that are non-zero (e.g., 1 to 2 for input values of 0 to 1 for ƒ(x)=2\hat{ }x). To make the output values for such functions ƒ(x) have a value of zero, “AND” gates may be added with a control signal indicating a zero output (e.g., control=0).

In another example, the MUX 150 (if present and utilized) is used to select between one of the second value (in this case, “ƒ(x)”) and the product value (in this case, “A×B”) at a time, and the selected one of the second value (e.g., “ƒ(x)”) and the product value (e.g., “A×B”) is input to a first input of the adder logic 160 (as denoted in FIG. 1A by dotted line arrows into and out of MUX 150) while the fifth value (in this case, “C”) is input to a second input of the adder logic 160, after bit-shifting a value being input in one of the first input or the second input. After summing, performing floating point range recovery, normalizing, and rounding, the FMA logic portion 115 outputs the output value 195′ (in this case, “ƒ(x)+C” or “(A×B)+C”).

The following is an example of alignment (for adding) of values. For adding “1.11×2\hat{ }8” to “1.0×2\hat{ }10,” one can use alignment to match the exponent, such that “0.0111×2\hat{ }10” is added to “1.0×2\hat{ }10.” Using the alignment shifter logic 155, “1.11×2\hat{ }8” is bit-shifted or binary shifted to the right by two (denoted by “>>2”), as follows:

$$1 \text{.0} \times 2 \hat{} 10 = 10000 \_ 00000 \qquad ( Eqn . 1 A )$$

$$1.11 \times 2 \hat{} 8 = 00111 \_ 00000$$

$$11100 \_ 00000 ≫ 2 = 00111 \_ 0.$$

The values are added as follows:

$$10000 \_ 00000 + 00111 \_ 00000 \qquad ( Eqn . 1 B )$$

$$10111 \_ 00000 = 1.01 \; 11 \times 2 \hat{} 10.$$

The following is an example of normalization (after subtraction) of values. For subtracting 1.11110×2\hat{ }10 from 1.11111×2\hat{ }10, as follows:

$$1.11111 \times 2 \hat{} 10 \qquad ( Eqn . 2 )$$

$$- 1.1111 \times 2 \hat{} 10$$

$$0.00001 \times 2 \hat{} 10.$$

Using the normalization logic 170, “0.00001×2\hat{ }10” is converted to “1.0×2\hat{ }5.” As described above, the output value 195′ is one of ƒ(x), (A×B), ƒ(x)+(A×B), ƒ(x)+C, (A×B)+C, or ƒ(x)+(A×B)+C. In an example, the output value 195′ that is output is displayed on a display device that is communicatively coupled to a computing system on which the integrated logic circuit is mounted or in which the integrated logic circuit is disposed. Alternatively or additionally, in some cases, the output value 195′ that is output is stored in an output register that is accessible by other components within the computing system.

Referring to example system 100B of FIG. 1B, the function evaluation logic 130 produces a second value by performing a function operation based on a first value (in this case, “x”), in a similar manner as described above with respect to example system 100A of FIG. 1A. In some examples, the second value (in this case, “ƒ(x)”) is input into either the MUX 150 (if present) or the alignment shifter logic 155 of the FMAC logic portion 120, similar to how the second value is input into either the MUX 150 or the alignment shifter logic 155 of the FMA logic portion 115 of FIG. 1A. In examples, the multiplier logic 140, the shift distance calculator logic 145 (if present), the MUX 150 (if present), the alignment shifter logic 155 (if present) of the FMAC logic portion 120 function in a manner similar to the corresponding components of the FMA logic portion 115 of FIG. 1A (as described in detail above). As such, the adder logic 160 receives bit-shifted values from the alignment shifter logic 155. For the FMAC logic portion 120, the alignment shifter logic 155 performs alignment of one or more values (e.g., one or more of an accumulated value (in this case, “D”)) obtained from the accumulator register 180, a product value (in this case, “A×B”) obtained from the multiplier logic 140, and/or the second value (in this case, “ƒ(x)”) in a manner similar to how the alignment shifter logic 155 performs alignment of input values (e.g., the second value (e.g., “ƒ(x)”) from the function evaluation logic 130, the product value (e.g., “A×B”) from the multiplier logic 140, and the fifth value (e.g., “C”) from the fourth register 190c in FIG. 1A), in some cases, based on a shift distance that is calculated by the shift distance calculator logic 145 for aligning bits of these input values. The FMAC logic portion 120, using the adder logic 160, performs one of:
(A) producing a first sum value by adding the second value (e.g., “ƒ(x)”) that is received from the function evaluation logic portion 110 (via MUX 150 (if present and utilized) and via the alignment shifter logic 155) and a bit-shifted accumulated value of the accumulated value (e.g., “D”) that is received from the alignment shifter logic 155;
(B) producing a second sum value by adding the product value (e.g., “A×B,” corresponding to one of the bit-shifted product value that is received from the alignment shifter logic 155 (via MUX 150 (if present and utilized) and via the alignment shifter logic 155)), and a bit-shifted accumulated value of the accumulated value (e.g., “D”) that is received from the alignment shifter logic 155;
(C) producing a third sum value by adding the second value (e.g., “ƒ(x)”) that is received from the function evaluation logic portion 110 via the alignment shifter logic 155, the product value (e.g., “A×B,” corresponding to one of the bit-shifted product value that is received from the alignment shifter logic 155), and the bit-shifted accumulated value of the accumulated value (e.g., “D”) that is received from the alignment shifter logic 155; or
(D) producing a fourth sum value by adding the second value (e.g., “ƒ(x)”) that is received from the function evaluation logic portion 110 via the alignment shifter logic 155 and the product value (e.g., “A×B,” corresponding to one of the bit-shifted product value that is received from the alignment shifter logic 155) (e.g., when the accumulated value (e.g., “D”) is zero).

In examples, the LZD logic 165 (or the LZA logic, if either present), the normalization logic 170, and the rounding logic 175 of the FMAC logic portion 120 function in a manner similar to the corresponding components of the FMA logic portion 115 of FIG. 1A (as described in detail above). The FMAC logic portion 120 performs at least one of: (1) outputting an output value 195″ from the rounding logic 175; or (2) storing the output value 195″ in the accumulator register 180. In examples, the output value 195″ is one of ƒ(x)+D, (A×B)+D, ƒ(x)+(A×B)+D, or ƒ(x)+(A×B). As each new value is input into the integrated logic circuit, the accumulated value is added to the resultant function evaluation for the new value, such that the output value 195″ becomes, for m number of iterations, one of Σⱼƒ(xⱼ), Σⱼ(Aⱼ×Bⱼ), or Σⱼ(ƒ(xⱼ)+(Aⱼ×Bⱼ)), where j=1 to m, where xⱼ for different j values may be different values, where Aⱼ for different j values may be different values, where Bⱼ for different j values may be different values. Herein, m and n are non-negative integer numbers that may be either all the same as each other, all different from each other, or some combination of same and different (e.g., one set of two or more having the same values with the others having different values, a plurality of sets of two or more having the same value with the others having different values, etc.). In an example, the output value 195″ that is output is displayed on a display device that is communicatively coupled to a computing system on which the integrated logic circuit is mounted or in which the integrated logic circuit is disposed. Alternatively or additionally, in some cases, the output value 195″ that is output is stored in an output register that is accessible by other components within the computing system.

With reference to example system 100C of FIG. 1C, each of the function evaluation logic portions 110a-110n functions in a manner similar to the function evaluation logic portion 110 of FIG. 1A or 1B, as described in detail above. In examples, each of the function evaluation logic portions 110a-110n receives one of input values from one of registers 185a-185n (in this, “x₁” through “xₙ”), and outputs one of output values 195a-195n (in this case, “ƒ₁(x₁)” through “ƒₙ(xₙ)”). In some examples, the function evaluation logic portions 110a-110n may correspond to outputs of functions that are one of all the same as each other functions (e.g., all e\hat{ }x), all different from each other (e.g., one or more e\hat{ }x, one or more 2\hat{ }x, one or more sin(x), one or more cos(x), or other function). The output values 195a-195n are input into the alignment shifter logic 155, then the adder logic 160 of the FMAC logic portion 120. In the example of FIG. 1C, no values are input into multiplier logic 140. The bit-shifted accumulated value of the accumulated value (e.g., “D”) that is received from the alignment shifter logic 155 is also input into the adder logic 160. As described above, for three or more values being added by the adder logic 160, the shift distance calculator logic 145 identifies a maximum exponent value among the three or more values, subtracts each exponent value from the maximum exponent value, and calculates a shift distance for each of the third or more values by subtracting the exponent value for that value from the maximum exponent value. In examples, the LZD logic (or the LZA logic, if either present), the normalization logic 170, and the rounding logic 175 of the FMAC logic portion 120 function in a manner similar to the corresponding components of the FMA logic portion 115 of FIG. 1A or the FMAC logic portion 120 of FIG. 1B (as described in detail above). The FMAC logic portion 120 of FIG. 1C performs at least one of: (1) outputting an output value 195′″ from the rounding logic 175; or (2) storing the output value 195′″ in the accumulator register 180. In examples, the output value 195′″ is ƒ₁(x₁)+ . . . +ƒₙ(xₙ)+D, ƒ₁(x₁)+ . . . +ƒₙ(xₙ), D+a sum of two or more of ƒ₁(x₁), . . . , or ƒₙ(xₙ), or a sum of two or more of ƒ₁(x₁), . . . , or ƒₙ(xₙ). As each new value is input into the integrated logic circuit, the accumulated value is added to the resultant function evaluation for the new value, such that the output value 195′″ becomes, for m number of iterations, Σⱼ[Σₖ ƒₖ (xₖⱼ)], where k=1 to n and j=1 to m, where xₖⱼ for different k and j values may be different values, where none or some of these function values has a value of zero. In an example, the output value 195′″ that is output is displayed on a display device that is communicatively coupled to a computing system on which the integrated logic circuit is mounted or in which the integrated logic circuit is disposed. Alternatively or additionally, in some cases, the output value 195′″ that is output is stored in an output register that is accessible by other components within the computing system.

In some examples, no values are input into multiplier logic 140 in the example of FIG. 1C, while in other examples, values “A” and “B” may be input. In examples, the multiplier logic 140, the shift distance calculator logic 145 (if present), the MUX 150 (if present), the alignment shifter logic 155 of the FMAC logic portion 120 function in a manner similar to the corresponding components of the FMA logic portion 115 of FIG. 1A or the FMAC logic portion 120 of FIG. 1B (as described in detail above). In such examples, the output value 195″″ is one of ƒ₁(x₁)+ . . . +ƒₙ(xₙ)+D, (A×B)+D, ƒ₁(x₁)+ . . . +ƒₙ(xₙ)+(A×B)+D, D+a sum of two or more of ƒ₁(x₁), . . . , or ƒₙ(xₙ), (A×B)+a sum of two or more of ƒ₁(x₁), . . . , or ƒₙ(xₙ), or a sum of two or more of ƒ₁(x₁), . . . , or ƒₙ(xₙ). As each new value is input into the integrated logic circuit, the accumulated value is added to the resultant function evaluation for the new value, such that the output value 195″ becomes, for m number of iterations, one of Σⱼ[Σₖ ƒₖ(xₖⱼ)], Σⱼ[Σₖ(Aₖⱼ×Bₖⱼ)], or Σⱼ[Σₖ(ƒₖ(xₖⱼ)+(Aₖⱼ×Bₖⱼ))], where k=1 to n and j=1 to m, where xₖⱼ for different k and j values may be different values, where Aₖⱼ for different k and j values may be different values, where Bₖⱼ for different k and j values may be different values, where none or some of these function values, none or some of the A values, and/or none or some of the B values has a value of zero. In other examples, the output value 195″″ that is output is displayed on a display device that is communicatively coupled to a computing system on which the integrated logic circuit is mounted or in which the integrated logic circuit is disposed. Alternatively or additionally, in some cases, the output value 195″″ that is output is stored in an output register that is accessible by other components within the computing system.

In other examples, not all of the function evaluation logic portions 110a-110n receive input values and/or produce output values, and, in such examples, only the function evaluation logic portions among the function evaluation logic portions 110a-110n that produce an output value (one of output values 195a-195n) directly input its output value to the adder logic 160, and the resultant output value 195′″ or 195″″ would reflect the output values that are actually added by the adder logic 160. Although the second value (or output value 195a-195n) is shown being input directly into adder logic 160, in some examples, the second value (or output value 195a-195n) may be input into multiplier logic 140. In such examples, the second value replaces one of the inputs A or B, and is multiplied with the other of the inputs A or B, and the other operations of the FMA logic portion 115 or the FMAC logic portion 120 will function as described above based on this replacement of one of the inputs to the multiplier logic 140.

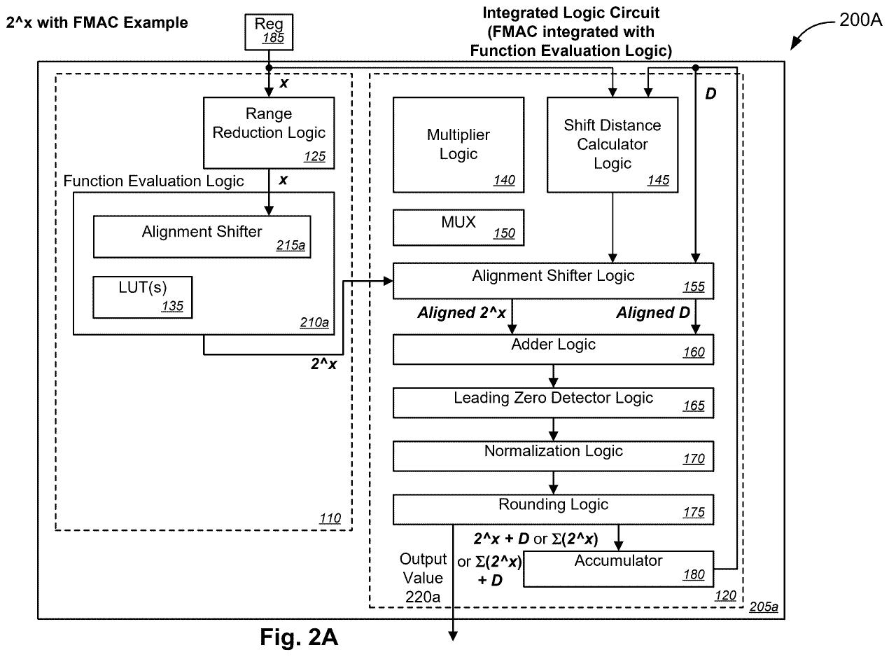

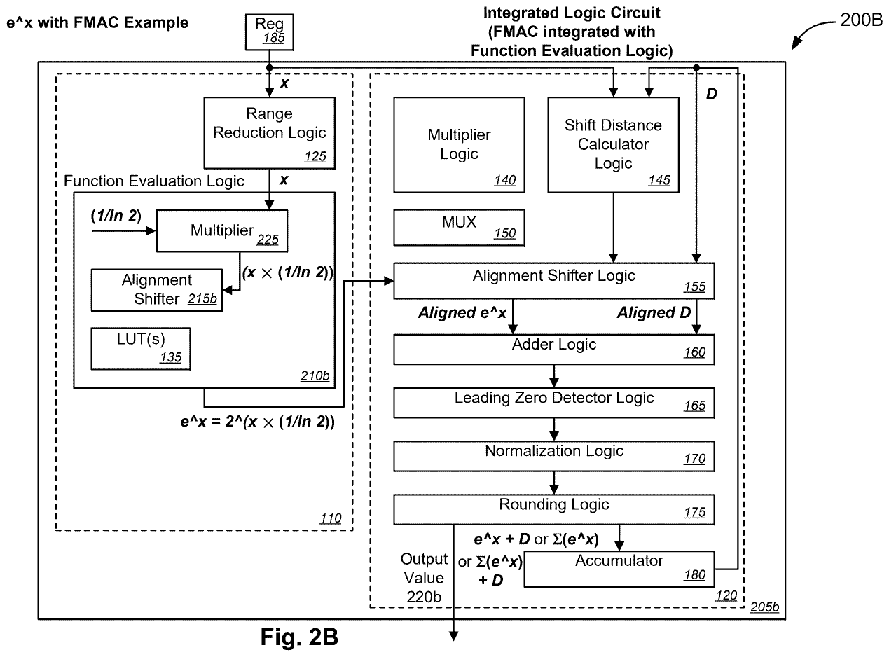

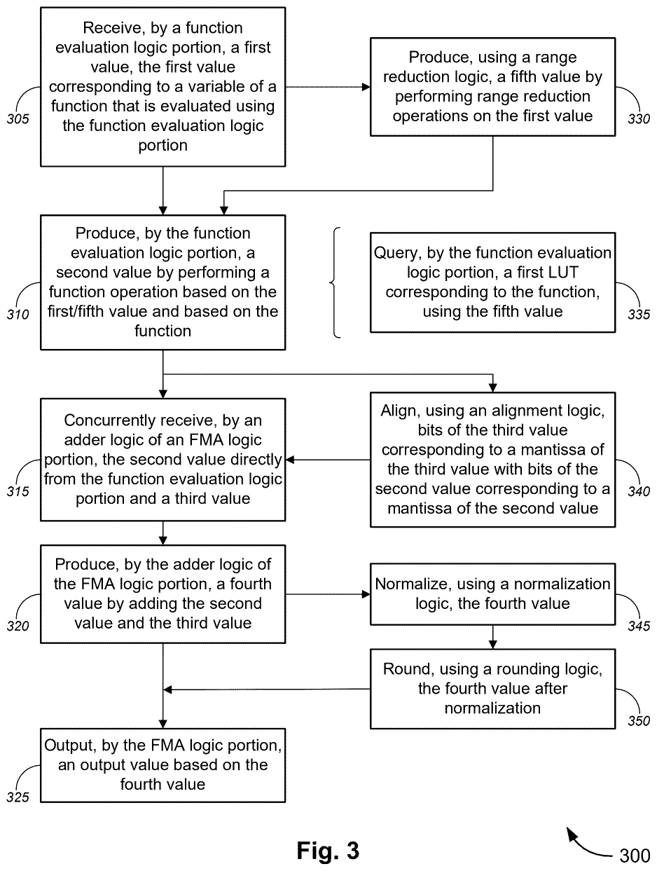

In operation, integrated logic circuit 105a, 105b, and/or 105c performs methods for implementing an integrated logic circuit with an FMA or FMAC integrated with function evaluation logic, as described in detail with respect to FIGS. 2A-5B. For example, example systems 200A and 200B as described below with respect to FIGS. 2A and 2B, and methods 300, 400, and 500 as described below with respect to FIGS. 3, 4, and 5A-5B may be applied with respect to the operations of system 100A, 100B, and/or 100C of FIGS. 1A, 1B, and/or 1C, respectively. In the manner as described above, compared with conventional logic circuit systems in which the conventional function evaluation logic portion(s) is separate from the conventional FMA or FMAC (thus necessitating additional registers as well as additional operations for inputting the outputs of the conventional functional evaluation logic portion(s) into an input(s) of the conventional FMA or FMAC), efficiency of operation of the logic circuit can be achieved because fewer registers and fewer operations are required. Accordingly, the integrated logic circuits 105a-105c (as described above) improve the functionality of any computing hardware or system that utilize such hardware integrated logic circuits to perform combined operations involving function evaluation logic and FMA or FMAC, as compared with systems using conventional function evaluation logic and conventional FMA or FMAC.

FIGS. 2A and 2B depict example systems 200A and 200B illustrating implementation of an integrated logic circuit with an FMAC integrated with specific examples of function evaluation logic. FIG. 2A depicts an example system 200A for implementing an integrated logic circuit with an FMAC integrated with function evaluation logic for a 2\hat{ }x exponential function. FIG. 2B depicts an example system 200B for implementing an integrated logic circuit with an FMAC integrated with function evaluation logic for an e\hat{ }x exponential function. In examples, integrated logic circuit 205a or 205b, function evaluation logic portion 110, FMAC 120, range reduction logic 125, function evaluation logic 210a or 210b, LUT(s) 135, multiplier logic 140, shift distance calculator logic 145, a MUX 150, alignment shifter logic 155, adder logic 160, LZD logic 165 (or LZA logic), normalization logic 170, rounding logic 175, accumulator 180, register 185, and output value 220a or 220b of FIG. 2A or 2B may be similar, if not identical, to the integrated logic circuit 105b or 105c, function evaluation logic portion 110 or 110a-110n, FMAC 120, range reduction logic 125 or 125a-125n, function evaluation logic 130 or 130a-130n, LUT(s) 135 or 135a-135n, multiplier logic 140, shift distance calculator logic 145, a MUX 150, alignment shifter logic 155, adder logic 160, LZD logic 165 (or LZA logic), normalization logic 170, rounding logic 175, accumulator 180, register 185 or 185a-185n, and output value 195″ or 195′″, respectively, of example system 100B of FIG. 1B or example system 100C of FIG. 1C, and the description of these components of example system 100B of FIG. 1B or example system 100C of FIG. 1C are similarly applicable to the corresponding components of FIG. 2A or 2B.

Although FIGS. 2A and 2B are directed to a 2\hat{ }x exponential function and an e\hat{ }x exponential function each integrated with an FMAC for the corresponding integrated logic circuit, a function evaluation logic for other functions—including another exponential function, a logarithmic function, a trigonometric function, a hyperbolic tangent function, a reciprocal function, a square root function, a sigmoid function, or a GELU function—may be integrated with the FMAC (or FMA of FIG. 1) instead. In an example, for a floating point exponential function represented by 2\hat{ }x (or 2^{x}), a floating point input x can be decomposed into the integer part and the fraction part. For a floating point range reduction from a floating point to fixed point format, as shown in Eqn. 3 below. The fraction part is evaluated using polynomial approximation, and the range of the fraction part is from zero to one, while the range of the 2^{x} exponential function is reduced to a range from one to two. The floating point result is calculated by 2^{I}×2^{F}, where 2^{I} is related to the exponent calculation, which is a simpler evaluation compared with evaluation of the fraction part. The 2\hat{ }x is described in detail below with respect to FIG. 2A. In another example, for a floating point natural exponential function represented by e\hat{ }x (or e^{x}), floating point e^{x} evaluation (as described in detail below with respect to FIG. 2B) can be performed by using the conversion, e^{x}=2^{x/ln 2}. The floating point input is scaled by 1/ln 2, followed by the steps of the 2^{x} function evaluation, as described below with respect to FIG. 2A. In yet another example, for a floating point reciprocal function represented by 1/x, range reduction can be performed by

$$\frac{1}{x} = \frac{1}{1. f \cdot {2}^{e}} = \frac{1}{1. f} \cdot {2}^{- e} ,$$

where ƒ and e are a fraction part and an exponent part of the floating point input number x, respectively, and

$$\frac{1}{1. f}$$

is for the function evaluation using polynomial approximation. The input range of ƒ in

$$\frac{1}{1. f}$$

is from zero to one, and the range of the evaluation results is from 0.5 to 1. The floating point result is calculated by the equation,

$$\frac{1}{1. f} \cdot {2}^{- e} ,$$

followed by mantissa and exponent adjustment in accordance with the IEEE 754 standard, which is incorporated herein by reference in its entirety for all purposes. In another example, for a floating point trigonometric function (e.g., sin(πx)), because trigonometric functions are periodic, the range of x for one cycle is from zero to two. The function curves for the four quadrants are symmetrical, so it is sufficient to evaluate the trigonometric function (e.g., sin(πx)) from 0 to 0.5. Once the function for one quadrant is evaluated, the range recovery can be performed by checking the symmetries. In still another example, for a floating point logarithmic function represented by log₂x, range reduction can be performed by the following conversion: log₂(1·ƒ·2^{e})=log₂(1·ƒ)+e. The input range for the polynomial approximation is from zero to one, and the range of the evaluated result is from zero to one. The addition of e with log₂(1·ƒ), followed by the normalization produces the evaluated floating point format results. In examples, for the example functions described above, the values produced after polynomial approximation and before the range recovery operation are input into the adder logic of the FMA or FMAC to perform ƒ(x)+D, followed by range recovery with the normalization and rounding steps.

With reference to example 200A of FIG. 2A, integrated logic circuit 205a performs 2\hat{ }x function evaluation, by using function evaluation logic 210a (which includes alignment shifter 215a), to ultimately produce an output value 220a from the integrated FMAC logic portion 120. In examples, the output value 220a, which includes one of 2\hat{ }x+D, Σ(2\hat{ }x), or Σ(2\hat{ }x)+D, is output from the integrated logic circuit 205a (in some cases, for storage in an output register and/or for display or use by other components, such as described above with respect to FIGS. 1A-1C) and/or stored in the accumulator register 180 (as described above with respect to FIGS. 1B and 1C). Similar to the operations as described above with respect to example systems 100A-100C of FIGS. 1A-1C, respectively, the range reduction logic 125 of the function evaluation logic portion 110 of integrated logic circuit 205a receives a first value (in this case, “x”) from register 185, and performs range reduction operations on the first value. To perform 2\hat{ }x (or 2^{x}) operations, the function evaluation logic 210a, using alignment shifter 215a, shifts binary bits by the first value. In the case that the first value is a floating point value, where the range of the first value or variable x can be from negative infinity to positive infinity, the range reduction operations convert the range of the first value or variable x to a range from zero to one, by converting or decomposing the first value into an integer part and a fractional part, such as the following:

$$x = - ∞ to + ∞ ; \qquad ( Eqn . 3 )$$

$$\begin{matrix}{2}^{x} = {2}^{I + F} \\ = {2}^{I} \times {2}^{F} \\ = ( 1 ≪ I ) \times {2}^{F} \\ = {2}^{F} ≪ I ,\end{matrix}$$

where FP is a floating point variable, I is the integer value, F is the fractional value (which is a value between zero and one). When x≥0, I is a positive value, and “<<” denotes a binary shift to the left by a number of bits based on the value that follows (in this case, the I value). For example, if x=1.5, then 2^{1.5}=2¹×2^{0.5}=2^{0.5}<<1, where 2¹ or <<1 corresponds to one binary shift to the left. The range of 2^{x} is from 1 to 2. When x<0, I is a negative value, and instead of “<<,” a “>>” is used and denotes a binary shift to the right by the number of bits based on the value that follows (in this case, the I value). For example, if x=−1.3, then 2^{-1.3}=2^{(-1+-0.3)}=2^{(-2+0.7)}=2^{-2×}2^{0.7}=2^{0.7}>>2, where 2⁻² or >>2 corresponds to two binary shifts to the right.

For a bfloat16 (also referred to as brain floating point or BF16) format, 1 bit corresponds to a sign bit, 8 bits correspond to an exponent width, and 8 bits correspond to a fraction or significand precision (also referred to as mantissa). For performing 2\hat{ }x function operations on a first value that is in bfloat16 format, the function evaluation logic 210a queries LUT(s) 135 based on the binary shifted 2^{F} value. For a half-precision floating point format (also referred to as float16 or FP16), 1 bit corresponds to a sign bit, 8 bits correspond to an exponent width, and 11 bits correspond to a fraction or significand precision. For performing 2\hat{ }x function operations on a first value that is in FP16 format, the function evaluation logic 210a performs one of querying a direct LUT, querying a bi-partite LUT, querying a multi-partite LUT, or performs linear polynomial approximation (e.g., “ax+b” approximation). For a single-precision floating point format (also referred to as float32 or FP32), 1 bit corresponds to a sign bit, 8 bits correspond to an exponent width, and 24 bits correspond to a fraction or significand precision. For performing 2\hat{ }x function operations on a first value that is in FP32 format, the function evaluation logic 210a performs quadratic polynomial approximation (e.g., “ax²+bx+c” approximation).

Turning back to FIG. 2A, the 2\hat{ }x value (which is one of a direct LUT, a bi-partite LUT value, a multi-partite LUT value, a linear polynomial approximation value, or a quadratic polynomial approximation value) is directly received by adder logic 160, which concurrently receives a bit-shifted accumulated value of accumulated value D from accumulator register 180, where D is a sum of previously added 2\hat{ }x values. In examples, the output value 220a that is output by the FMAC logic portion 120 (after normalization by normalization logic 170 and rounding by rounding logic 175) and/or stored in the accumulator register 180 includes one of 2\hat{ }x+D, Σ(2\hat{ }x), or Σ(2\hat{ }x)+D.

Referring to example system 200B of FIG. 2B, because e\hat{ }x (or e^{x}) corresponds to 2\hat{ }(x×(1/ln 2)), the function evaluation logic 210b of the function evaluation logic portion 110 of integrated logic circuit 205b of FIG. 2B includes a multiplier logic 225 and an alignment shifter 215b, where the alignment shifter 215b is similar to alignment shifter 215a of function evaluation logic 210a of FIG. 2A. Here, the multiplier logic 225 multiplies a constant value of (1/ln 2) with the first value of x, and the resultant value of (x×(1/ln 2)) is fed into alignment shifter 215b, which functions in a similar manner to alignment shifter 215a of FIG. 2A that performs evaluation of 2\hat{ }x. The function evaluation logic portion 110 and the FMAC logic portion 120 of integrated logic circuit 205b of FIG. 2B otherwise functions in a similar manner as the function evaluation logic portion 110 and the FMAC logic portion 120 of integrated logic circuit 205a of FIG. 2A. In examples, the output value 220b that is output by the FMAC logic portion 120 (after normalization by normalization logic 170 and rounding by rounding logic 175) and/or stored in the accumulator register 180 includes one of e\hat{ }x+D, Σ(e\hat{ }x), or Σ(e\hat{ }x)+D.

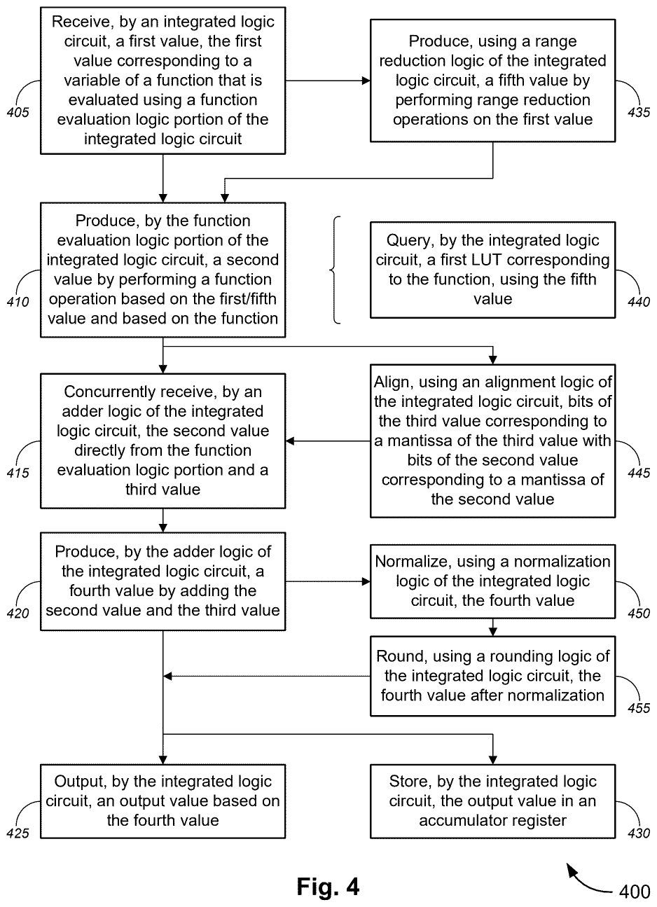

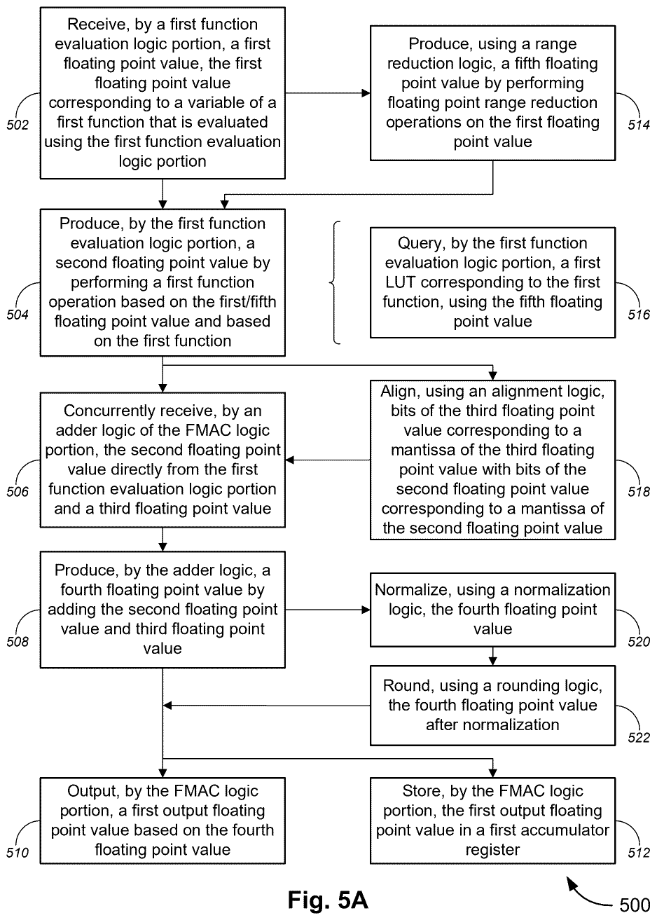

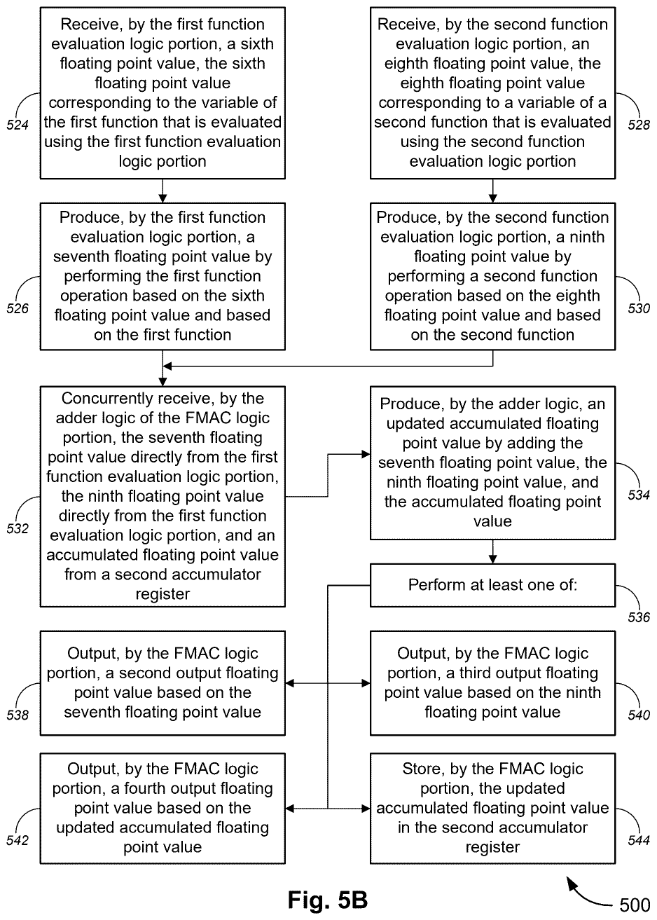

With reference to FIG. 3, the operations of example method 300 may be performed by an integrated logic circuit (e.g., integrated logic circuit 100A of FIG. 1A). Referring to FIG. 4, the operations of example method 400 may be performed by an integrated logic circuit (e.g., at least one of integrated logic circuits 100A-100C, 200A, or 200B of FIG. 1A-1C, 2A, or 2B). With reference to FIGS. 5A and 5B, the operations of example method 500 may be performed by an integrated logic circuit (e.g., at least one of integrated logic circuits 100B, 100C, 200A, or 200B of FIG. 1B, 1C, 2A, or 2B).

FIG. 3 depicts an example method 300 for implementing an integrated logic circuit with an FMA integrated with function evaluation logic.

In the example of FIG. 3, method 300, at operation 305, includes a function evaluation logic portion of an integrated logic circuit receiving a first value corresponding to a variable of a function that is evaluated using the function evaluation logic portion. At operation 310, the function evaluation logic portion produces a second value by performing a function operation based on the first value and based on the function. At operation 315, an adder logic (e.g., adder logic 160 of FIG. 1A) of an FMA logic portion (e.g., FMA logic portion 115 of FIG. 1A) of the integrated logic circuit concurrently receives (i) the second value directly from the function evaluation logic portion and (ii) a third value. In some examples, the third value is one or more of: (a) a product value that is produced by a multiplier logic (e.g., multiplier logic 140 of FIG. 1A) of the FMA logic portion multiplying two input values; (b) a stored value that is obtained from a register (e.g., register 190c of FIG. 1A) that is coupled to the FMA logic portion; and/or (c) a result value that is directly received from each of one or more second function evaluation logic portions (e.g., one or more of function evaluation logic portions 110a-110n of FIG. 1C) that are integrated with the function evaluation logic portion and the FMA logic portion.

At operation 320, the adder logic produces a fourth value by adding the second value and the third value. At operation 325, the FMA logic portion outputs an output value based on the fourth value. In an example, the output value is displayed on a display device that is communicatively coupled to a computing system on which the integrated logic circuit is mounted or in which the integrated logic circuit is disposed. Alternatively or additionally, in some cases, the output value is stored in a register that is accessible by other components within the computing system.

In examples, after receiving the first value (at operation 305), the function evaluation logic portion uses a range reduction logic (e.g., range reduction logic 125 of FIG. 1A) to produce a fifth value by performing range reduction operations on the first value (at operation 330), range reduction operations being described in detail above with respect to FIGS. 1A-1C and 2A-2B. In such cases, performing the function operation (at operation 310) includes the function evaluation logic portion querying a first LUT (e.g., LUT(s) 135 of FIG. 1A) corresponding to the function, using the fifth value (at operation 335), where the second value is obtained from the first LUT, the second value corresponding to a LUT approximation of a result of the function for the fifth value.

In some examples, prior to the adder logic receiving the second value and the third value (at operation 315), the FMA logic portion, using an alignment logic (e.g., alignment shifter logic 155 of FIG. 1A), aligns bits of the third value corresponding to a mantissa of the third value with bits of the second value corresponding to a mantissa of the second value (at operation 340), in a manner as described above with respect to alignment logic functionality. In some instances, the FMA logic portion further includes a shift distance calculator logic (e.g., shift distance calculator logic 145 of FIG. 1A), and aligning the bits of the third value corresponding to the mantissa of the third value with bits of the second value corresponding to the mantissa of the second value (at operation 340) is based on a shift distance calculated by the shift distance calculator logic.

In examples, after producing the fourth value (at operation 320), the FMA logic portion, using a normalization logic (e.g., normalization logic 170 of FIG. 1A), normalizes the fourth value (at operation 345), in a manner as described above with respect to normalization logic functionality. At operation 350, the FMA logic portion, using a rounding logic (e.g., rounding logic 175 of FIG. 1A), rounds the fourth value after normalization, in a manner as described above with respect to rounding logic functionality. In such cases, the output value that is output (at operation 325) corresponds to the normalized and rounded fourth value (from operations 345 and 350).

In some examples, the function includes a transcendental function including at least one of an exponential function, a logarithmic function, a trigonometric function, a hyperbolic tangent function, a reciprocal function, a square root function, a reciprocal of a square root function, a sigmoid function, or a GELU function. In the case that each of the first value, the second value, the third value, and the fourth value is a binary value representing a floating point value, at least one of an exponential function, a logarithmic function, a trigonometric function, a hyperbolic tangent function, a reciprocal function, a square root function, a reciprocal of a square root function, a sigmoid function, or a GELU function is at least one of a floating point exponential function, a floating point logarithmic function, a floating point trigonometric function, a floating point hyperbolic tangent function, a floating point reciprocal function, a floating point square root function, a reciprocal of a floating point square root function, a floating point sigmoid function, or a floating point GELU function, respectively.

FIG. 4 depicts another example method 400 for implementing an integrated logic circuit with an FMA or FMAC integrated with function evaluation logic.

In the example of FIG. 4, method 400, at operation 405, includes an integrated logic circuit receiving a first value corresponding to a variable of a function that is evaluated using a function evaluation logic portion of the integrated logic circuit. In some examples, the integrated logic circuit is one of an integrated logic circuit with an FMA integrated with function evaluation logic (e.g., integrated logic circuit 105a of FIG. 1A) or an integrated logic circuit with an FMAC integrated with function evaluation logic (e.g., integrated logic circuit 105b, 105c, 205a, or 205b of FIG. 1B, 1C, 2A, or 2B). At operation 410, the function evaluation logic portion of the integrated logic circuit produces a second value by performing a function operation based on the first value and based on the function. At operation 415, an adder logic (e.g., adder logic 160 of FIGS. 1A-1C and 2A-2B) of the integrated logic circuit concurrently receives (i) the second value directly from the function evaluation logic portion and (ii) a third value. In some examples, the third value is one or more of: (a) a product value that is produced by a multiplier logic (e.g., multiplier logic 140 of FIGS. 1A-1C and 2A-2B) of the integrated logic circuit multiplying two input values; (b) a stored value that is obtained from a register (e.g., accumulator 180 of FIG. 1B, 1C, 2A, or 2B) that is coupled to the integrated logic circuit; or (c) a result value that is directly received from each of one or more second function evaluation logic portions (e.g., one or more of function evaluation logic portions 110a-110n of FIG. 1C) that are integrated with the function evaluation logic portion (e.g., another one of function evaluation logic portions 110a-110n of FIG. 1C) and the integrated logic circuit.

At operation 420, the adder logic produces a fourth value by adding the second value and the third value. The integrated logic circuit performs at least one of: (1) outputting an output value based on the fourth value (at operation 425); and/or (2) storing the output value in an accumulator register (at operation 430). In an example, the output value that is output (at operation 425) is displayed on a display device that is communicatively coupled to a computing system on which the integrated logic circuit is mounted or in which the integrated logic circuit is disposed. Alternatively or additionally, in some cases, the output value that is output (at operation 425) is stored in an output register that is accessible by other components within the computing system.

In examples, after receiving the first value (at operation 405), the integrated logic circuit uses a range reduction logic (e.g., range reduction logic 125 or 125a-125n of FIGS. 1A-1C and 2A-2B) to produce a fifth value by performing range reduction operations on the first value (at operation 435), range reduction operations being described in detail above with respect to FIGS. 1A-1C and 2A-2B. In such cases, performing the function operation (at operation 410) includes the integrated logic circuit querying a first LUT (e.g., LUT(s) 135 or 135a-135n of FIGS. 1A-1C or 2A-2B) corresponding to the function, using the fifth value (at operation 440), where the second value is obtained from the first LUT, the second value corresponding to a LUT approximation of a result of the function for the fifth value.

In some examples, prior to the adder logic receiving the second value and the third value (at operation 415), the integrated logic circuit, using an alignment logic (e.g., alignment shifter logic 155 of FIGS. 1A-1C and 2A-2B), aligns bits of the third value corresponding to a mantissa of the third value with bits of the second value corresponding to a mantissa of the second value (at operation 445), in a manner as described above with respect to alignment logic functionality. In some instances, aligning the bits of the third value corresponding to the mantissa of the third value with bits of the second value corresponding to the mantissa of the second value (at operation 445) is based on a shift distance calculated by a shift distance calculator logic (e.g., shift distance calculator logic 145 of FIGS. 1A-1C and 2A-2B).

In examples, after producing the fourth value (at operation 420), the integrated logic circuit, using a normalization logic (e.g., normalization logic 170 of FIGS. 1A-1C and 2A-2B), normalizes the fourth value (at operation 450), in a manner as described above with respect to normalization logic functionality. At operation 455, the integrated logic circuit, using a rounding logic (e.g., rounding logic 175 of FIGS. 1A-1C and 2A-2B), rounds the fourth value after normalization, in a manner as described above with respect to rounding logic functionality. In such cases, the output value that is output (at operation 425) and/or stored in the accumulator register (at operation 430) corresponds to the normalized and rounded fourth value (from operations 450 and 455).

In some examples, the function includes a transcendental function including at least one of an exponential function, a logarithmic function, a trigonometric function, a hyperbolic tangent function, a reciprocal function, a square root function, a reciprocal of a square root function, a sigmoid function, or a GELU function. In the case that each of the first value, the second value, the third value, and the fourth value is a binary value representing a floating point value, at least one of an exponential function, a logarithmic function, a trigonometric function, a hyperbolic tangent function, a reciprocal function, a square root function, a reciprocal of a square root function, a sigmoid function, or a GELU function is at least one of a floating point exponential function, a floating point logarithmic function, a floating point trigonometric function, a floating point hyperbolic tangent function, a floating point reciprocal function, a floating point square root function, a reciprocal of a floating point square root function, a floating point sigmoid function, or a floating point GELU function, respectively.

FIGS. 5A and 5B depict yet another example method 500 for implementing an integrated logic circuit with an FMAC integrated with function evaluation logic.

In the example of FIG. 5A, method 500, at operation 502, includes a first function evaluation logic portion (e.g., function evaluation logic portion 110 or 110a-110n of FIG. 1B, 1C, 2A, or 2B) of an integrated logic circuit receiving a first floating point value corresponding to a variable of a first function that is evaluated using a first function evaluation logic portion of the integrated logic circuit. In some examples, the integrated logic circuit is an integrated logic circuit with an FMAC integrated with first function evaluation logic (e.g., integrated logic circuit 105b, 105c, 205a, or 205b of FIG. 1B, 1C, 2A, or 2B). At operation 504, the first function evaluation logic portion of the integrated logic circuit produces a second floating point value by performing a first function operation based on the first floating point value and based on the first function. At operation 506, an adder logic (e.g., adder logic 160 of FIGS. 1A-1C and 2A-2B) of a FMAC logic portion (e.g., FMAC logic portion 120 of FIG. 1B, 1C, 2A, or 2B) of the integrated logic circuit concurrently receives (i) the second floating point value directly from the first function evaluation logic portion and (ii) a third floating point value. In some examples, the third floating point value is one or more of: (a) a product value that is produced by a multiplier logic (e.g., multiplier logic 140 of FIG. 1B, 1C, 2A, or 2B) of the FMAC logic portion of the integrated logic circuit multiplying two input values; (b) a stored value that is obtained from a first accumulator register (e.g., accumulator 180 of FIG. 1B, 1C, 2A, or 2B) that is coupled to the FMAC logic portion of the integrated logic circuit; or (c) a result value that is directly received from each of one or more second function evaluation logic portions (e.g., one or more of function evaluation logic portions 110a-110n of FIG. 1C) that are integrated with the first function evaluation logic portion (e.g., another one of function evaluation logic portions 110a-110n of FIG. 1C) and the FMAC logic portion of the integrated logic circuit.

At operation 508, the adder logic produces a fourth floating point value by adding the second floating point value and the third floating point value. The FMAC logic portion of the integrated logic circuit performs at least one of: (1) outputting a first output floating point value based on the fourth floating point value (at operation 510); and/or (2) storing the first output floating point value in the first accumulator register (at operation 512). In an example, the output floating point value that is output (at operation 510) is displayed on a display device that is communicatively coupled to a computing system on which the integrated logic circuit is mounted or in which the integrated logic circuit is disposed. Alternatively or additionally, in some cases, the output floating point value that is output (at operation 510) is stored in an output register that is accessible by other components within the computing system.

In examples, after receiving the first floating point value (at operation 502), the first function evaluation logic portion of the integrated logic circuit uses a range reduction logic (e.g., range reduction logic 125 or 125a-125n of FIG. 1B, 1C, 2A, or 2B) to produce a fifth floating point value by performing range reduction operations on the first floating point value (at operation 514), range reduction operations being described in detail above with respect to FIGS. 1A-1C and 2A-2B. In such cases, performing the first function operation (at operation 504) includes the first function evaluation logic portion of the integrated logic circuit querying a first LUT (e.g., LUT(s) 135 or 135a-135n of FIG. 1B, 1C, 2A, or 2B) corresponding to the first function, using the fifth floating point value (at operation 516), where the second floating point value is obtained from the first LUT, the second floating point value corresponding to a LUT approximation of a result of the first function for the fifth floating point value.

In some examples, prior to the adder logic receiving the second floating point value and the third floating point value (at operation 506), the FMAC logic portion of the integrated logic circuit, using an alignment logic (e.g., alignment shifter logic 155 of FIG. 1B, 1C, 2A, or 2B), aligns bits of the third floating point value corresponding to a mantissa of the third floating point value with bits of the second floating point value corresponding to a mantissa of the second floating point value (at operation 518), in a manner as described above with respect to alignment logic first functionality. In some instances, aligning the bits of the third floating point value corresponding to the mantissa of the third floating point value with bits of the second floating point value corresponding to the mantissa of the second floating point value (at operation 518) is based on a shift distance calculated by a shift distance calculator logic (e.g., shift distance calculator logic 145 of FIG. 1B, 1C, 2A, or 2B).

In examples, after producing the fourth floating point value (at operation 508), the FMAC logic portion of the integrated logic circuit, using a normalization logic (e.g., normalization logic 170 of FIG. 1B, 1C, 2A, or 2B), normalizes the fourth floating point value (at operation 520), in a manner as described above with respect to normalization logic functionality. At operation 522, the FMAC logic portion of the integrated logic circuit, using a rounding logic (e.g., rounding logic 175 of FIG. 1B, 1C, 2A, or 2B), rounds the fourth floating point value after normalization, in a manner as described above with respect to rounding logic functionality. In such cases, the first output floating point value that is output (at operation 510) and/or stored in the first accumulator register (at operation 512) corresponds to the normalized and rounded fourth floating point value (from operations 520 and 522).

Referring to FIG. 5B, at operation 524, the first function evaluation logic portion receives a sixth floating point value corresponding to the variable of the first function that is evaluated using the first function evaluation logic portion. At operation 526, the first function evaluation logic portion produces a seventh floating point value by performing the first function operation based on the sixth floating point value and based on the first function. Concurrent with the processes at operations 524 and 526, the second function evaluation logic portion receives an eighth floating point value corresponding to a variable of a second function that is evaluated using the second function evaluation logic portion (at operation 528). At operation 530, the second function evaluation logic portion produces a ninth floating point value by performing a second function operation based on the eighth floating point value and based on the second function.

At operation 532, the adder logic of the FMAC logic portion concurrently receives the seventh floating point value directly from the first function evaluation logic portion, the ninth floating point value directly from the first function evaluation logic portion, and an accumulated floating point value from a second accumulator register (e.g., accumulator register 180 of FIG. 1C). In examples, the second accumulator register stores a previous sum of values produced by the first function evaluation logic portion and the second function evaluation logic portion. At operation 534, the adder logic of the FMAC logic portion produces an updated accumulated floating point value by adding the seventh floating point value, the ninth floating point value, and the accumulated floating point value. At operation 536, the FMAC logic portion performs at least one of:
(1) outputting a second output floating point value based on the seventh floating point value (at operation 538);
(2) outputting a third output floating point value based on the ninth floating point value (at operation 540);
(3) outputting a fourth output floating point value based on the updated accumulated floating point value (at operation 542); or
(4) storing the updated accumulated floating point value in the second accumulator register (at operation 544).

In some examples, each of the first function and the second function includes at least one of a floating point exponential function, a floating point logarithmic function, a floating point trigonometric function, a floating point hyperbolic tangent function, a floating point reciprocal function, a floating point square root function, a reciprocal of a floating point square root function, a floating point sigmoid function, or a floating point GELU function, respectively.

While the techniques and procedures in methods 300, 400, and 500 are depicted and/or described in a certain order for purposes of illustration, it should be appreciated that certain procedures may be reordered and/or omitted within the scope of various embodiments. Moreover, while the methods 300, 400, and 500 may be implemented by or with (and, in some cases, are described below with respect to) the systems, examples, or embodiments 100A, 100B, 100C, 200A, and/or 200B of FIGS. 1A, 1B, 1C, 2A, and/or 2B, respectively (or components thereof), such methods may also be implemented using any suitable hardware (or software) implementation. Similarly, while each of the systems, examples, or embodiments 100A, 100B, 100C, 200A, and/or 200B of FIGS. 1A, 1B, 1C, 2A, and/or 2B, respectively (or components thereof), can operate according to the methods 300, 400, and 500 (e.g., by executing instructions embodied on a computer readable medium), the systems, examples, or embodiments 100A, 100B, 100C, 200A, and/or 200B of FIGS. 1A, 1B, 1C, 2A, and/or 2B can each also operate according to other modes of operation and/or perform other suitable procedures.

As should be appreciated from the foregoing, the present technology provides multiple technical benefits and solutions to technical problems. For instance, performing function evaluation (such as evaluation of SoftMax or similar operations) generally raises multiple technical problems. For instance, one technical problem is that conventional hardware systems involve two steps: (1) calculating exponential function values using dedicated hardware in a floating point number format; and (2) accumulating the evaluated values using a floating point FMA. Accordingly, such conventional methods require use of dedicated hardware for evaluation of the exponential function, and the FMA hardware separately requires two instructions, one for the exponential function evaluation and another for the FMA calculation. Further, outputs for the function evaluation hardware are stored in registers whose stored values are input into the FMA hardware. The present technology provides for an integrated logic circuit with an FMA or FMAC integrated with function evaluation logic. In particular, the present technology combines the two operations (namely, function evaluation and FMA or FMAC calculation) into a single instruction by merging or integrating the function evaluation hardware logic and the FMA or FMAC hardware logic. Further, the present technology is applicable to not only the exponential function operations, but a logarithmic function, a trigonometric function, a hyperbolic tangent function, a reciprocal function, a square root function, a reciprocal of a square root function, a sigmoid function, and/or a GELU function as well. The same operations performed by the integrated logic circuit of the present technology require fewer steps, fewer hardware components (e.g., registers for storing intermediate values and components for linking the registers to the hardware components), and fewer instructions, without any increase in latency. Cumulatively, in addition to the reduce hardware requirements, the present technology results in a reduced processor load, increased processing (due to fewer steps being required), which may result in energy savings, enhanced reliability, and/or reduced error rate (due to fewer rounding steps required).

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

In this detailed description, for the purposes of explanation, numerous specific details are set forth to provide a thorough understanding of the described embodiments. It will be apparent to one skilled in the art, however, that other embodiments of the present invention may be practiced without some of these specific details. In other instances, certain structures and devices are shown in block diagram form. While aspects of the technology may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the detailed description does not limit the technology, but instead, the proper scope of the technology is defined by the appended claims. Examples may take the form of a hardware implementation, or an entirely software implementation, or an implementation combining software and hardware aspects. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features. The detailed description is, therefore, not to be taken in a limiting sense.

Aspects of the present invention, for example, are described above with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

What is claimed is:

1. An integrated logic circuit with a fused multiplier and adder (“FMA”) integrated with function evaluation logic, the integrated logic circuit comprising:
a function evaluation logic portion; and
an FMA logic portion that is integrated with the function evaluation logic portion;
wherein the integrated logic circuit performs operations comprising:
receiving, by the function evaluation logic portion, a first value, the first value corresponding to a variable of a function that is evaluated using the function evaluation logic portion;
producing, by the function evaluation logic portion, a second value by performing a function operation based on the first value and based on the function;
concurrently receiving, by an adder logic of the FMA logic portion, the second value directly from the function evaluation logic portion and a third value;
producing, by the adder logic of the FMA logic portion, a fourth value by adding the second value and the third value; and
outputting, by the FMA logic portion, an output value based on the fourth value.

2. The integrated logic circuit of claim 1, wherein the third value is one or more of:
a product value that is produced by a multiplier logic of the FMA logic portion multiplying two input values;
a stored value that is obtained from a register that is coupled to the FMA logic portion; or
a result value that is directly received from a second function evaluation logic portion that is integrated with the function evaluation logic portion and the FMA logic portion.

3. The integrated logic circuit of claim 1,
wherein the function evaluation logic portion includes a range reduction logic; and
wherein the operations further comprise:
producing, using the range reduction logic, a fifth value by performing range reduction operations on the first value;
wherein performing the function operation based on the first value and based on the function comprises querying, by the function evaluation logic portion, a first look-up table (“LUT”) corresponding to the function, using the fifth value, wherein the second value is obtained from the first LUT, the second value corresponding to a LUT approximation of a result of the function for the fifth value.

4. The integrated logic circuit of claim 1,
wherein the FMA logic portion further includes an alignment logic, a normalization logic, and a rounding logic;
wherein the operations further comprise:
aligning, using the alignment logic, bits of the third value corresponding to a mantissa of the third value with bits of the second value corresponding to a mantissa of the second value, prior to the adder logic adding the second value and the third value;
normalizing, using the normalization logic, the fourth value; and
rounding, using the rounding logic, the fourth value after normalization.

5. The integrated logic circuit of claim 4,
wherein the FMA logic portion further includes a shift distance calculator logic;
wherein aligning the bits of the third value corresponding to a mantissa of the third value with bits of the second value corresponding to a mantissa of the second value is based on a shift distance calculated by the shift distance calculator logic.

6. The integrated logic circuit of claim 1, wherein the function includes a transcendental function including at least one of an exponential function, a logarithmic function, a trigonometric function, a hyperbolic tangent function, a reciprocal function, a square root function, a reciprocal of a square root function, a sigmoid function, or a Gaussian error linear unit (“GELU”) function.

7. The integrated logic circuit of claim 6, wherein each of the first value, the second value, the third value, and the fourth value is a binary value representing a floating point value, wherein the function includes a floating point transcendental function including at least one of a floating point exponential function, a floating point logarithmic function, a floating point trigonometric function, a floating point hyperbolic tangent function, a floating point reciprocal function, a floating point square root function, a reciprocal of a floating point square root function, a floating point sigmoid function, or a floating point GELU function.

8. A logic circuit-implemented method, comprising:
receiving, by an integrated logic circuit, a first value, the first value corresponding to a variable of a function that is evaluated using a function evaluation logic portion of the integrated logic circuit;
producing, by the function evaluation logic portion of the integrated logic circuit, a second value by performing a function operation based on the first value and based on the function;
concurrently receiving, by an adder logic of the integrated logic circuit, the second value directly from the function evaluation logic portion and a third value;
producing, by the adder logic of the integrated logic circuit, a fourth value by adding the second value and the third value; and
performing at least one of:
outputting, by the integrated logic circuit, an output value based on the fourth value; and
storing, by the integrated logic circuit, the output value in an accumulator register.

9. The logic circuit-implemented method of claim 8, wherein the integrated logic circuit is one of an integrated logic circuit with a fused multiplier and adder (“FMA”) integrated with function evaluation logic or an integrated logic circuit with a fused multiplier and accumulator (“FMAC”) integrated with function evaluation logic.

10. The logic circuit-implemented method of claim 8, wherein the third value is one or more of:
a product value that is produced by a multiplier logic of the integrated logic circuit multiplying two input values;
a stored value that is obtained from a register that is coupled to the integrated logic circuit; or
a result value that is directly received from a second function evaluation logic portion that is integrated with the function evaluation logic portion and the integrated logic circuit.

11. The logic circuit-implemented method of claim 8, further comprising:
producing, using a range reduction logic of the integrated logic circuit, a fifth value by performing range reduction operations on the first value;
wherein performing the function operation based on the first value and based on the function comprises querying, by the integrated logic circuit, a first look-up table (“LUT”) corresponding to the function, using the fifth value, wherein the second value is obtained from the first LUT, the second value corresponding to a LUT approximation of a result of the function for the fifth value.

12. The logic circuit-implemented method of claim 8, further comprising:
aligning, using an alignment logic of the integrated logic circuit, bits of the third value corresponding to a mantissa of the third value with bits of the second value corresponding to a mantissa of the second value, based on a shift distance calculated by a shift distance calculator logic of the integrated logic circuit, prior to the adder logic adding the second value and the third value;
normalizing, using a normalization logic of the integrated logic circuit, the fourth value; and
rounding, using a rounding logic of the integrated logic circuit, the fourth value after normalization.

13. The logic circuit-implemented method of claim 8, wherein the function includes a transcendental function including at least one of an exponential function, a logarithmic function, a trigonometric function, a hyperbolic tangent function, a reciprocal function, a square root function, a reciprocal of a square root function, a sigmoid function, or a Gaussian error linear unit (“GELU”) function.

14. The logic circuit-implemented method of claim 13, wherein each of the first value, the second value, the third value, and the fourth value is a binary value representing a floating point value, wherein the function includes a floating point transcendental function including at least one of a floating point exponential function, a floating point logarithmic function, a floating point trigonometric function, a floating point hyperbolic tangent function, a floating point reciprocal function, a floating point square root function, a reciprocal of a floating point square root function, a floating point sigmoid function, or a floating point GELU function.

15. An integrated logic circuit with a fused multiplier and accumulator (“FMAC”) integrated with function evaluation logic, comprising:
a first function evaluation logic portion; and
an FMAC logic portion that is integrated with the first function evaluation logic portion;
wherein the integrated logic circuit performs first operations comprising:
receiving, by the first function evaluation logic portion, a first floating point value, the first floating point value corresponding to a variable of a first function that is evaluated using the first function evaluation logic portion;
producing, by the first function evaluation logic portion, a second floating point value by performing a first function operation based on the first floating point value and based on the first function;
concurrently receiving, by an adder logic of the FMAC logic portion, the second floating point value directly from the first function evaluation logic portion and a third floating point value;
producing, by the adder logic of the FMAC logic portion, a fourth floating point value by adding the second floating point value and third floating point value; and
performing at least one of:
outputting, by the FMAC logic portion, a first output floating point value based on the fourth floating point value; or
storing, by the FMAC logic portion, the first output floating point value in a first accumulator register.

16. The integrated logic circuit of claim 15, wherein the third floating point value is one or more of:
a product value that is produced by a multiplier logic of the FMAC logic portion multiplying two input values;
a stored value that is obtained from the first accumulator register that is coupled to the FMAC logic portion; or
a result value that is directly received from a second function evaluation logic portion that is integrated with the first function evaluation logic portion and the FMAC logic portion.

17. The integrated logic circuit of claim 15,
wherein the first function evaluation logic portion includes a range reduction logic; and
wherein the first operations further comprise:
producing, using the range reduction logic, a fifth floating point value by performing floating point range reduction operations on the first floating point value;
wherein performing the first function operation based on the first floating point value and based on the first function comprises querying, by the first function evaluation logic portion, a first look-up table (“LUT”) corresponding to the first function, using the fifth floating point value, wherein the second floating point value is obtained from the first LUT, the second floating point value corresponding to a LUT approximation of a result of the first function for the fifth floating point value.

18. The integrated logic circuit of claim 15,
wherein the FMAC logic portion further includes a shift distance calculator logic, an alignment logic, a normalization logic, and a rounding logic;
wherein the first operations further comprise:
aligning, using the alignment logic, bits of the third floating point value corresponding to a mantissa of the third floating point value with bits of the second floating point value corresponding to a mantissa of the second floating point value, based on a shift distance calculated by the shift distance calculator logic, prior to the adder logic adding the second floating point value and the third floating point value;
normalizing, using the normalization logic, the fourth floating point value; and
rounding, using the rounding logic, the fourth floating point value after normalization.

19. The integrated logic circuit of claim 15, further comprising:
a second function evaluation logic portion;
wherein the integrated logic circuit performs second operations comprising:
receiving, by the first function evaluation logic portion, a sixth floating point value, the sixth floating point value corresponding to the variable of the first function that is evaluated using the first function evaluation logic portion;
producing, by the first function evaluation logic portion, a seventh floating point value by performing the first function operation based on the sixth floating point value and based on the first function;
receiving, by the second function evaluation logic portion, an eighth floating point value, the eighth floating point value corresponding to a variable of a second function that is evaluated using the second function evaluation logic portion;
producing, by the second function evaluation logic portion, a ninth floating point value by performing a second function operation based on the eighth floating point value and based on the second function;
concurrently receiving, by the adder logic of the FMAC logic portion, the seventh floating point value directly from the first function evaluation logic portion, the ninth floating point value directly from the first function evaluation logic portion, and an accumulated floating point value from a second accumulator register, the second accumulator register storing a previous sum of values produced by the first function evaluation logic portion and the second function evaluation logic portion;
producing, by the adder logic of the FMAC logic portion, an updated accumulated floating point value by adding the seventh floating point value, the ninth floating point value, and the accumulated floating point value; and
performing at least one of:
outputting, by the FMAC logic portion, a second output floating point value based on the seventh floating point value;
outputting, by the FMAC logic portion, a third output floating point value based on the ninth floating point value;
outputting, by the FMAC logic portion, a fourth output floating point value based on the updated accumulated floating point value; or
storing, by the FMAC logic portion, the updated accumulated floating point value in the second accumulator register.

20. The integrated logic circuit of claim 19, wherein each of the first function and the second function includes a floating point transcendental function including at least one of a floating point exponential function, a floating point logarithmic function, a floating point trigonometric function, a floating point hyperbolic tangent function, a floating point reciprocal function, a floating point square root function, a reciprocal of a floating point square root function, a floating point sigmoid function, or a floating point GELU function.
